(19) United States
(12) Patent Application Publication
(10) Pub. No.: US 2013/0310150 A1
(43) Pub. Date: Nov. 21, 2013

(54) GAME DEVICE, GAME SYSTEM, METHOD OF CONTROLLING A GAME DEVICE, PROGRAM, AND INFORMATION STORAGE MEDIUM

(71) Applicants: Yoshinori Mishina, Yokohama-shi (JP); Yasuo Yoshikawa, Nagoya-shi (JP); Takashi Takeda, Kotoku (JP)

(72) Inventors: Yoshinori Mishina, Yokohama-shi (JP); Yasuo Yoshikawa, Nagoya-shi (JP); Takashi Takeda, Kotoku (JP)

(73) Assignee: KONAMI DIGITAL ENTERTAINMENT CO., LTD., Minato-ku, Tokyo (JP)

(21) Appl. No.: 13/982,610

(22) PCT Filed: Jun. 6, 2012
(86) PCT No.: PCT/JP2012/064581

§ 371 Date: Jul. 30, 2013

(30) Foreign Application Priority Data
Jun. 14, 2011 (JP) 2011-132461
May 2, 2012 (JP) 2012-105124

(51) Int. Cl. A63F 13/00

(52) U.S. Cl. CPC A63F 13/00
USPC 463/23

(57) ABSTRACT

First part executing means (72) of a game system (1) changes a game difficulty level in a first part, where a player plays, by changing a first game parameter in the case where another player has performed a supportive operation or an obstructive operation. Second part executing means (74) changes a game difficulty level in a second part, where the other player plays, by changing a second game parameter based on the result of play that is played by the other player in the first part with the first game parameter changed.

### TECHNICAL FIELD

The present invention relates to a game device, a game system, a method of controlling a game device, a program, and an information storage medium.

### BACKGROUND ART

There have heretofore been video games in which a player can operate to affect the play of another player. Patent Literature 1, for example, describes a technology in which an operation performed by one player is used as a basis for changing a parameter that indicates the skill value or the like of a character operated by another player, thereby changing the difficulty level of a game that the other player plays.

### CITATION LIST

### Patent Literature

Patent Literature 1: JP 2003-117248 A

### SUMMARY OF INVENTION

### Technical Problem

In a conventional technology, however, a player could change the difficulty level of a game that another player plays in a manner that would be to their own advantage. Then, the players would manipulate the game difficulty levels of one another, thereby taking the fun out of the game.

The present invention has been made in view of the problem described above, and an object of the present invention is therefore to provide a game device, a game system, a method of controlling a game device, a program, and an information storage medium which enable a player to change the level of difficulty of a game of another player while maintaining the fun of the game.

### Solution to Problem

In order to solve the above-mentioned problem, according to the present invention, there are provided a game device and game system for executing a game that includes a first part where a player plays the game and a second part where another player plays the game, the game device and the game system each including: first part executing means for executing the game that is played by the player in the first part, based on a first game parameter; and second part executing means for executing the game that is played by the other player in the second part, based on a second game parameter, in which, in a case where the other player performs any one of a supportive operation and an obstructive operation with respect to the player, the first part executing means changes the first game parameter to change a game difficulty level in the first part where the player plays, and in a case where the other player has performed any one of the supportive operation and the obstructive operation with respect to the player in the first part, the second part executing means changes the second game parameter to change a game difficulty level in the second part where the other player plays.

According to the present invention, there is provided a method of controlling a game device for executing a game that includes a first part where a player plays the game and a second part where another player plays the game, the method including: a first part executing step of executing the game that is played by the player in the first part, based on a first game parameter; and a second part executing step of executing the game that is played by the other player in the second part, based on a second game parameter, in which the first part executing step includes changing, in a case where the other player performs any one of a supportive operation and an obstructive operation with respect to the player, the first game parameter to change a game difficulty level in the first part where the player plays, and the second part executing step includes changing, in a case where the other player has performed any one of the supportive operation and the obstructive operation with respect to the player in the first part, the second game parameter to change a game difficulty level in the second part where the other player plays.

According to the present invention, there is provided a program for causing a computer to function as a game device for executing a game that includes a first part where a player plays the game and a second part where another player plays the game, the game device including: first part executing means for executing the game that is played by the player in the first part, based on a first game parameter; and second part executing means for executing the game that is played by the other player in the second part, based on a second game parameter, in which, in a case where the other player performs anyone of a supportive operation and an obstructive operation with respect to the player, the first part executing means changes the first game parameter to change a game difficulty level in the first part where the player plays, and in a case where the other player has performed any one of the supportive operation and the obstructive operation with respect to the player in the first part, the second part executing means changes the second game parameter to change a game difficulty level in the second part where the other player plays.

According to the present invention, there is also provided a non-transitory computer-readable information storage medium having recorded thereon the above-mentioned program.

According to the present invention, the player is able to change the level of difficulty of the game of another player while maintaining the fun of the game.

Further, in an aspect of the present invention, the second part executing means determines the second game parameter based on a result of play that has been played by the player with the game difficulty level in the first part changed by the first part executing means.

Further, in an aspect of the present invention, the other player performs any one of the supportive operation and the obstructive operation one or a plurality of times, and the first part executing means determines the first game parameter based on a number of times that the other player has performed any one of the supportive operation and the obstructive operation.

Further, in an aspect of the present invention, the second part executing means determines the second game parameter based on the number of times that the other player has performed any one of the supportive operation and the obstructive operation.

Further, in an aspect of the present invention, the game device further includes means for obtaining information about performance of any one of the player and the other player in the game, from means for storing the information, and the first part executing means determines the first game parameter based on the information about the performance of any one of the player and the other player in the game.

Further, in an aspect of the present invention, the second part executing means determines the second game parameter based on the information about the performance of any one of the player and the other player.

Further, in an aspect of the present invention, the game is a game in which the player and the other player each operate one of a plurality of characters, the game device further includes means for obtaining information about a characteristic trait of each of the plurality of characters, from means for storing the information, and the first part executing means determines the first game parameter based on the information about the character trait of the one of the plurality of characters that is operated by any one of the player and the other player.

Further, in an aspect of the present invention, the second part executing means determines the second game parameter based on the information about the character trait of the one of the plurality of characters that is operated by any one of the player and the other player.

Further, in an aspect of the present invention, the other player performs any one of the supportive operation and the obstructive operation one or a plurality of times, and the first part executing means displays, on a game screen of the first part, an indicator indicating that the other player has performed any one of the supportive operation and the obstructive operation, based on a number of times that any one of the supportive operation and the obstructive operation has been performed.

Further, in an aspect of the present invention, the second part executing means displays, on a game screen of the second part, an indicator indicating that the other player has performed any one of the supportive operation and the obstructive operation, based on the number of times that any one of the supportive operation and the obstructive operation has been performed.

Further, in an aspect of the present invention, the game device further includes means for obtaining information about performance of any one of the player and the other player in the game, from means for storing the information, and the first part executing means displays, on a game screen of the first part, an indicator indicating that the other player has performed any one of the supportive operation and the obstructive operation, based on the information about any one of the performance of the player and the other player in the game.

Further, in an aspect of the present invention, the second part executing means displays, on a game screen of the second part, an indicator indicating that the other player has performed any one of the supportive operation and the obstructive operation, based on the information about the performance of any one of the player and the other player in the game.

Further, in an aspect of the present invention, the game is a game in which the player and the other player each operate one of a plurality of characters, the game device further includes means for obtaining information about a characteristic trait of each of the plurality of characters, from means for storing the information, and the first part executing means displays, on a game screen of the first part, an indicator indicating that the other player has performed any one of the supportive operation and the obstructive operation, based on the information about the character trait of the one of the plurality of characters that is operated by any one of the player and the other player.

Further, in an aspect of the present invention, the second part executing means displays, on a game screen of the second part, an indicator indicating that the other player has performed any one of the supportive operation and the obstructive operation, based on the information about the character trait of the one of the plurality of characters that is operated by any one of the player and the other player.

### BRIEF DESCRIPTION OF DRAWINGS

FIG. 1 A diagram illustrating the overall configuration of a game system according to the present invention.

FIG. 2 A diagram illustrating the hardware configuration of game devices according to an embodiment of the present invention.

FIG. 3 A figure illustrating an example of a game screen.

FIG. 4 A figure illustrating a game operation that is performed to cause a character to swing.

FIG. 5 A figure illustrating an example of a game screen where a first player is pressured.

FIG. 6 A figure illustrating an example of a game screen where the first player is cheered on.

FIG. 7 A figure illustrating an example of a game screen that is displayed when a second player is pressured in return.

FIG. 8 A figure illustrating an example of a game screen that is displayed when the second player is cheered on in return.

FIG. 9 A block diagram illustrating functions that are implemented by the game system.

FIG. 10 A figure illustrating an example of storing data of a first game parameter and a second game parameter.

FIG. 11 A flow chart illustrating an example of processing executed in the game system.

FIG. 12 A flow chart illustrating an example of the processing executed in the game system.

FIG. 13 A figure illustrating the association between a supportive operation/obstructive operation count and information about a game parameter changing method.

FIG. 14 A figure illustrating an example of the association between a character level and a game parameter changing method.

FIG. 15 A figure illustrating an example of data that associates information about a character trait with a game parameter changing method.

FIG. 16 A figure illustrating the association between a supportive operation/obstructive operation count and information about a message display method.

FIG. 17 A figure illustrating the association between a character level and information about a message display method.

FIG. 18 A figure illustrating the association between a character trait and information about a message display method.

FIG. 19 A figure illustrating the association between information about a play result of the first player and information about a game parameter changing method.

FIG. 20 A figure outlining processing that is executed when the present invention is applied to a game system for executing a card game.

### DESCRIPTION OF EMBODIMENT

### 1. Embodiment

An embodiment of the present invention is described in detail below with reference to the drawings.

[1-1. Overall Configuration of a Game System]

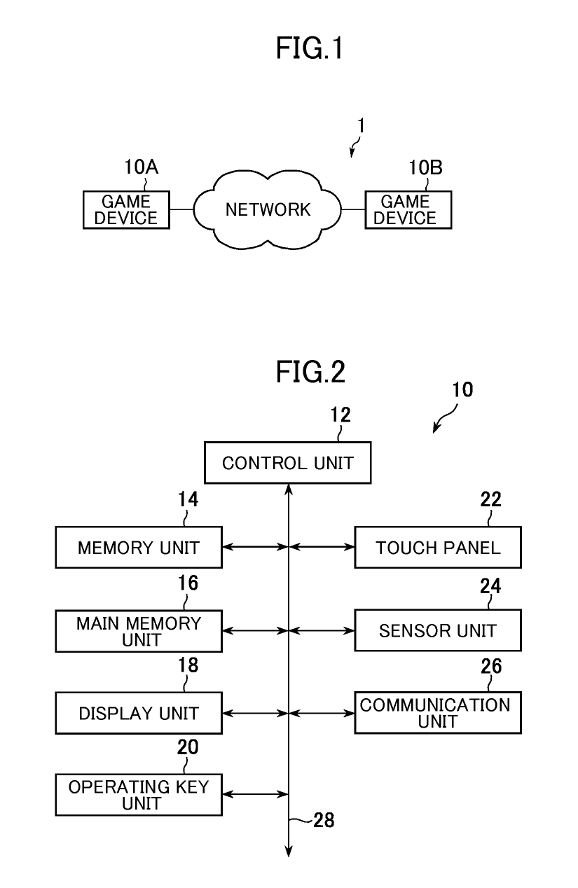

FIG. 1 is a diagram illustrating the overall configuration of a game system according to the present invention. As illustrated in FIG. 1, the game system which is denoted by 1 includes, for example, a plurality of game devices 10A and 10B (hereinafter collectively and simply referred to as game devices 10). The machines constituting the game system 1 are connected to each other via a network in a manner that allows data communication.

This embodiment describes a case of executing a competitive game in which two players compete with each other. One of the two players is hereinafter referred to as a “first player” and the other player is hereinafter referred to as a “second player”. The first player and the second player are collectively and simply referred to as players. The first player operates, for example, the game device 10A and the second player operates the game device 10B.

For example, one of the plurality of game devices 10 included in the game system 1 plays the role of a server that takes overall control of the competitive game executed in the game system 1. Described below is a case where the game device 10A assumes the role of the server.

The game device 10A first receives an operation performed by the first player on the game device 10A. The game device 10A which plays the role of the server 10A also receives data that indicates the specifics of an operation performed by the second player and obtained by the game device 10B, which is the other game device. Based on the operations performed on the respective game devices 10, the game device 10A which plays the role of the server executes the competitive game and updates various types of data relevant to the competitive game. The game device 10 which plays the role of the server further transmits the specifics of updates made to the various types of data relevant to the competitive game to the game device 10B, which is the other game device, via a network.

When receiving the latest data, the game device 10B updates data that is stored in the game device 10B based on the received data. The game system 1 thus makes the various types of data relevant to the competitive game consistent between the game devices 10.

The game system 1, which includes two game devices 10 in this embodiment to simplify the description, can include an arbitrary number of game devices 10.

[1-2. Hardware Configuration of the Game Devices]

FIG. 2 is a diagram illustrating the hardware configuration of the game devices according to the embodiment of the present invention. This embodiment describes a case where the game device 10A and the game device 10B have the same configuration. The game devices 10 are implemented by known computers. The game devices 10 described in this embodiment are implemented by portable terminals (for example, portable game machines or cellular phones), but the game devices 10 may be consumer game machines, arcade game machines, personal computers, or the like.

As illustrated in FIG. 2, the game devices 10 each include, among others, a control unit 12, a memory unit 14, a main memory unit 16, a display unit 18, an operating key unit 20, a touch panel 22, a sensor unit 24, and a communication unit 26, which are connected to one another via a bus 28, for example. The hardware configuration of the game devices 10 is not limited to the example of FIG. 2 and the game devices 10 may include various types of hardware included in known portable terminals (for example, an SD card slot and an optical disc reproducing unit).

The control unit 12 controls the components of the game device 10 based on an operating system stored in the memory unit 14, programs stored in various storage mediums which are connected externally (for example, an SD card), and various types of data obtained via the communication unit 26.

The memory unit 14 includes a non-volatile storage medium such as a flash memory. The memory unit 14 stores an operating system and the like. The main memory unit 16 includes a RAM. A program and the like stored in the memory unit 14 are written in the main memory unit 16 as the need arises. The main memory unit 16 is also used as a work memory of the control unit 12.

The display unit 18 is one or more known monitors, e.g., liquid crystal display panels. The display unit 18 displays, for example, an image rendered in a VRAM (not shown). The operating key unit 20 is operating means provided for a user to input various operations, and includes a four-way navigation key, various buttons, and the like. The touch panel 22 is disposed so as to overlap with the display unit 18. The touch panel 22 transmits information about a point of external contact to the control unit 12.

The sensor unit 24 includes a CCD camera, a GPS sensor, a gyro sensor, an electronic compass (geomagnetic sensor), an acceleration sensor, and the like. The touch panel 22 and the sensor unit 24 may implement operating means which enables a user to perform various operations. The communication unit 26 exchanges data with an external device (e.g., the other game device 10B) via a network.

[1-3. Game Executed in the Game System]

The game system 1 executes a competitive game that includes a first part in which one player (e.g., the first player) plays a game and a second part in which the other player (e.g., the second player) plays the game. In one part, the player who is not the one playing the game in this part stands by until the player playing in this part finishes. In other words, the first part is the first player's turn to play the game and the second part is the second player's turn to play the game.

This embodiment describes a case of executing a golf video game simulating a golf match in which a first character operated by the first player and a second character operated by the second player compete with each other. In the first part of the golf game, the first player plays the game by controlling the first character to make a shot. In the second part of the golf game, on the other hand, the second player plays the game by controlling the second character to make a shot. The golf game is implemented by executing a program that is read out of the memory unit 14 or various storage media.

When the golf game is started, a game space representing an imaginary golf course is constructed in the main memory unit 16. Data indicating the game space is shared between the game devices 10A and 10B. A game screen showing a view of the game space from a given viewpoint is displayed on the display unit 18.

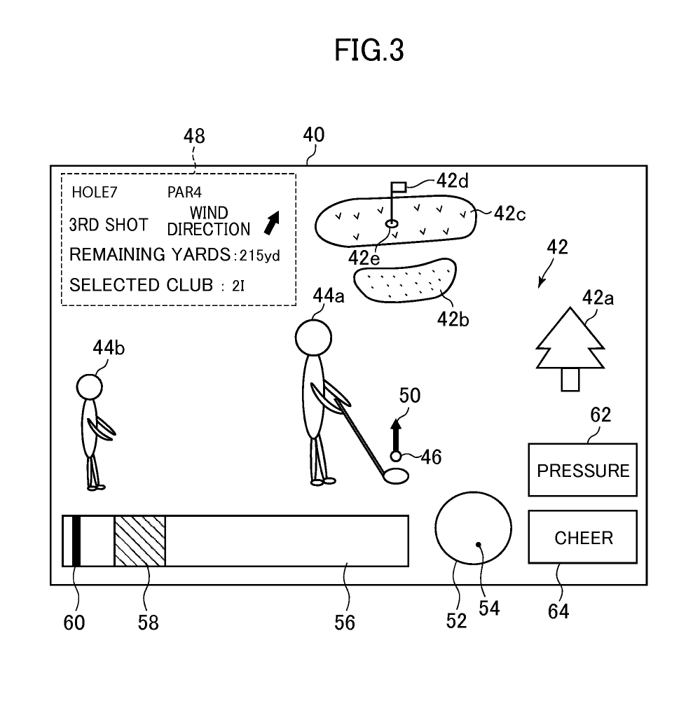

FIG. 3 is a figure illustrating an example of the game screen. This embodiment describes a case where a game screen 40 displayed on the game device 10A and a game screen 40 displayed on the game device 10B display the same data. As illustrated in FIG. 3, the game screen 40 displays a field 42 which represents the field of the golf course. A tree 42a, a bunker 42b, a green 42c, a pin 42d, and a hole 42e are arranged on the field 42 as in an actual golf course.

The players plays the game by operating characters 44 which are put on the field 42. Here, the first player operates a first character 44a and the second player operates a second character 44b. The simple term “characters 44” is hereinafter used to refer to those characters collectively.

The players perform given game operations to cause the characters 44 to hit a ball 46. The players aim to get the ball 46 into the hole 42e with fewer shots.

The order in which the characters 44 hit the ball 46 is determined by a given method. In other words, the order of the parts in which the players play the game is determined by a given method. For instance, the player operating the character 44 whose ball 46 is farthest from the hole 42e performs a game operation for hitting the ball 46.

In the situation of FIG. 3, it is the turn of the first character 44a to hit the ball 46. In other words, it is the first part where the first player plays the game. In this case, the first player performs a game operation to cause the first character 44a to hit the ball 46. The second player waits for the second part where the second player plays the game, which arrives after the first player finishes the game operation for causing the first character 44a to make a shot.

The game screen 40 also displays game information 48 which indicates the current situation of the game being executed. Displayed as the game information 48 are, for example, the hole number in the round, par, the current number of shots taken by the character 44, the direction of the wind in the game space, the distance between the ball 46 and the hole 42e, and the club selected by the player.

The player performs a given game operation to specify a direction in which the character 44 is to hit the ball 46 and the strength of the swing.

The direction in which the character 44 is to hit the ball 46 is indicated by, for example, a direction indicator mark 50. The direction indicated by the direction indicator mark 50 changes to reflect the operation of the player.

A hit point at which the character 44 is to hit the ball 46 is indicated by, for example, a ball mark 52 and a hit point icon 54. The hit point icon 54 is displayed within the ball mark 52. The position of the hit point icon 54 changes to reflect the operation of the player. The angle at which the ball 46 shoots out and the curve of the shot vary depending on the position of the hit point icon 54.

The strength of the swing of the character 44 is indicated by, for example, a swing gauge 56. In other words, the swing gauge 56 is an area used by the player to specify the carry of the ball 46. The swing gauge 56 includes an impact zone 58 and a cursor 60. The player performs a given game operation to move or stop the cursor 60 along the swing gauge 56. To which point the cursor 60 is moved or at which point the cursor 60 is stopped determines the strength and accuracy of the swing.

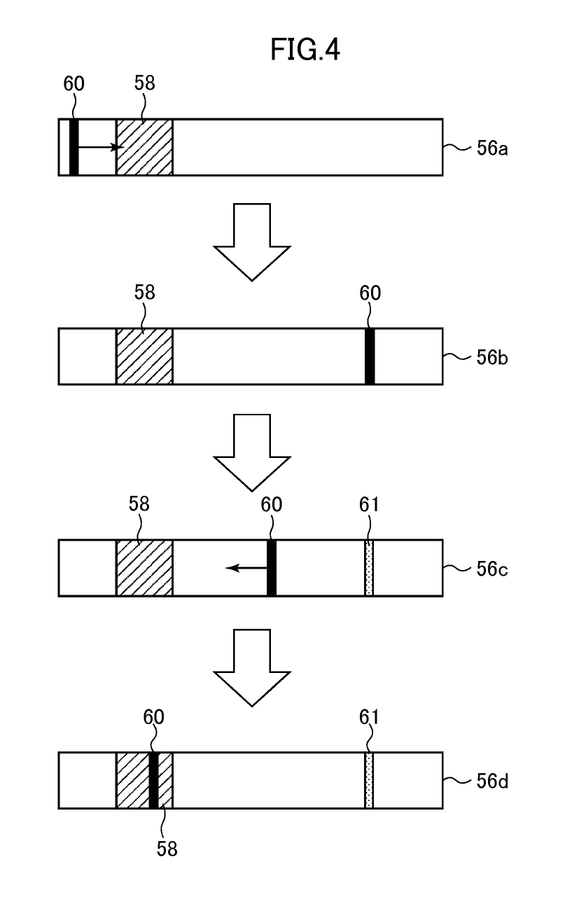

FIG. 4 is a figure illustrating a game operation that is performed to cause the character 44 to swing. When the player presses a given button of the operating key unit 20, for example, the cursor 60 moves from an initial point (e.g., the left end of the swing gauge 56) in the rightward direction (see the state of a swing gauge 56a in FIG. 4). The swing of the character 44 is stronger when the cursor 60 moves farther in the rightward direction. In other words, the carry of the ball 46 is longer when the cursor 60 moves farther in the rightward direction.

When the player presses a given button of the operating key unit 20 while the cursor 60 is moving to the right, the rightward movement of the cursor 60 stops (see the state of a swing gauge 56b in FIG. 4) and the cursor 60 starts moving in the leftward direction (see the state of a swing gauge 56c in FIG. 4). The point at which the cursor 60 switches from the rightward move to the leftward move is indicated by a swing strength mark 61.

This means that the swing of the character 44 is stronger when the swing strength mark 61 is located farther in the rightward direction. In other words, the carry of the ball 46 is longer when the swing strength mark 61 is located farther in the rightward direction. The speed at which the cursor 60 moves in the leftward direction may be set faster than the speed at which the cursor 60 moves in the rightward direction.

When the player subsequently presses a given button of the operating key unit 20, the movement of the cursor 60 in the leftward direction stops (see the state of a swing gauge 56d in FIG. 4). In the case where the cursor 60 stops at a point inside the impact zone 58, for example, the player can hit the ball 46 at the hit point specified by the player (i.e., the hit point indicated by the hit point icon 54) and cause the ball 46 to lift with the strength specified by the player (i.e., the strength indicated by the swing strength mark 61), and in the direction specified by the player (i.e., the direction indicated by the direction indicator mark 50).

In the case where the cursor 60 stops at a point outside the impact zone 58, on the other hand, the player cannot hit the ball 46 at the hit point specified by the player and cause the ball 46 to lift with the strength specified by the player and in the direction specified by the player. Specifically, the character 44 makes a missed shot in which the ball 46 curves in a direction that is not intended by the player, or the character 44 makes an air shot.

The player causes the character 44 to swing by moving the cursor 60 along the swing gauge 56 in the manner described above. Stoping the cursor 60 inside the impact zone is more difficult when, for example, the impact zone 58 is narrower, and thus it is difficult to make a successful shot. Raising the moving speed of the cursor 60 also makes it difficult to stop the cursor 60 inside the impact zone 58 and consequently to make a successful shot.

Returning to FIG. 3, the game screen 40 displays a pressuring button 62 and a cheering button 64. The pressuring button 62 and the cheering button 64 can be selected by the player operating the character 44 that is not the one about to swing. In the case of FIG. 3, the current part of the golf game is the first part where it is the turn of the first character 44a operated by the first player to swing, and the second player operating the second character 44b can therefore select the pressuring button 62 and the cheering button 64.

The pressuring button 62 is used to pressure the player who plays in the current part so that the character 44 operated by this player messes up a shot.

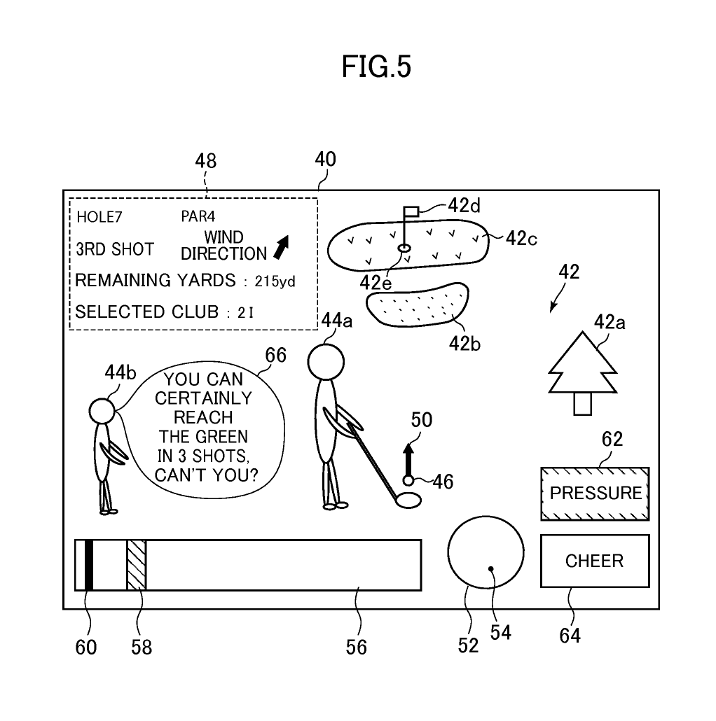

FIG. 5 is a figure illustrating an example of the game screen 40 where the first player is being pressured. As illustrated in the example of FIG. 5, when the second player selects the pressuring button 62, a message 66 with which the second character 44b pressures the first character 44a is displayed on the game screen 40.

An example of the result of the second player pressuring the first player is the narrowing of the impact zone 58. Specifically, the pressure caused by the second player on the first player makes it difficult for the first player to stop the cursor 60 inside the impact zone 58, which means that the chance of the first character 44a making a successful shot is decreased.

The cheering button 64, on the other hand, is used to cheer on the player who plays in the current part to help the character 44 make a successful shot.

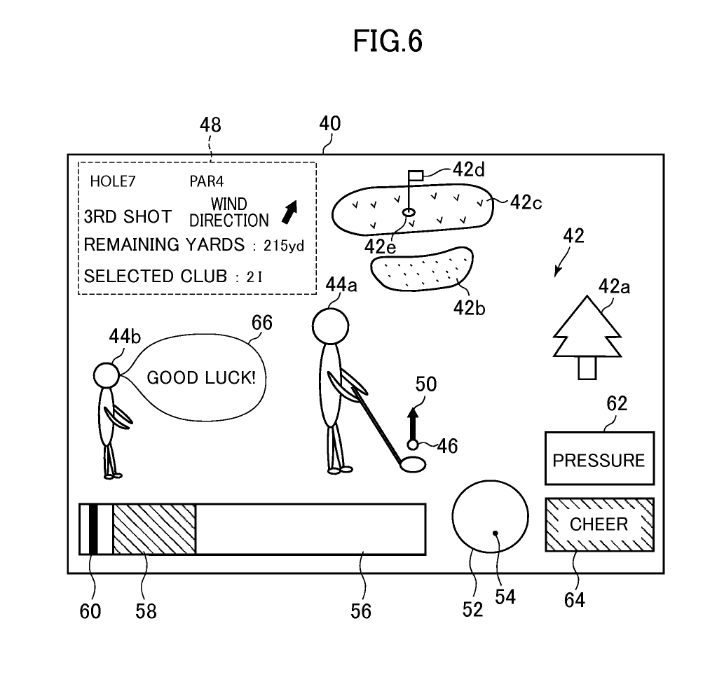

FIG. 6 is a figure illustrating an example of the game screen 40 where the first player is being cheered on. As illustrated in the example of FIG. 6, when the second player selects the cheering button 64, the message 66 with which the second character 44b cheers on the first character 44a is displayed on the game screen 40.

An example of the result of the second player cheering on the first player is the widening of the impact zone 58. Specifically, the cheering for the first player by the second player makes it easy for the first player to stop the cursor 60 inside the impact zone 58, which means that the chance of making a successful shot is increased.

Thus, an example of the result of the second player pressuring the first player or cheering on the first player is a change in the width of the impact zone 58. In other words, the second player can select the pressuring button 62 or the cheering button 64 to change the game difficulty level in the first part, thereby helping the first player to play successfully or unsuccessfully.

This embodiment describes a case where the width of the impact zone 58 is changed when the second player causes the second character 44b to make a shot based on the result of play that is played by the first player with the game difficulty level in the first part changed.

For example, in the case where the first player manages to cause the first character 44a to make a successful shot with the impact zone 58 narrowed due to the pressuring on the first player by the second player, the second player is pressured in return.

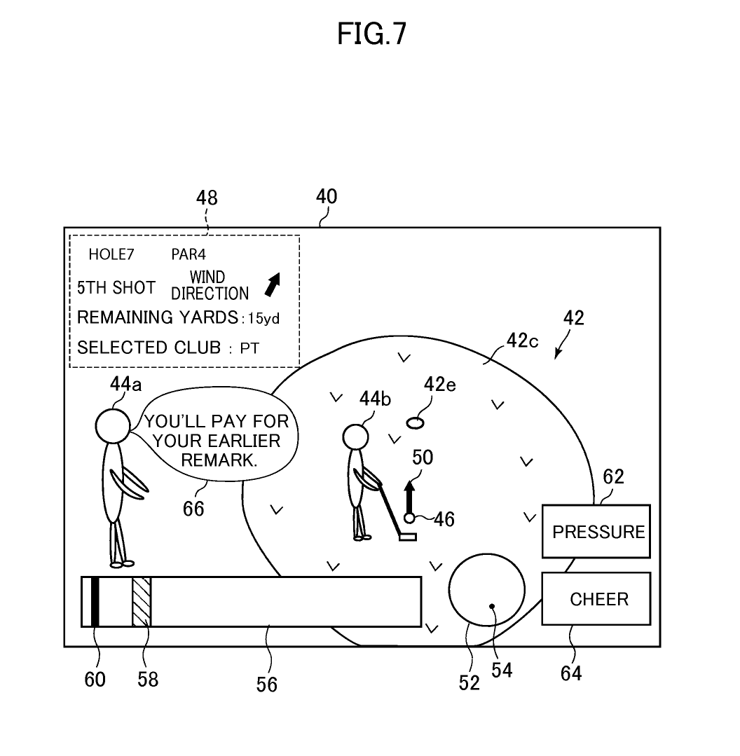

FIG. 7 is a figure illustrating an example of the game screen 40 that is displayed when the second player is pressured in return. As illustrated in FIG. 7, the impact zone 58 is narrowed when the second part where the second player plays the game (where the second character 44b takes a shot) arrives. The game screen 40 of this second part further displays the message 66 with which the first player pressures the second player in return.

To give an opposite example, in the case where the first player manages to cause the first character 44a to make a successful shot with the impact zone 58 widened owing to the cheering for the first player by the second player, the second player is cheered on in return.

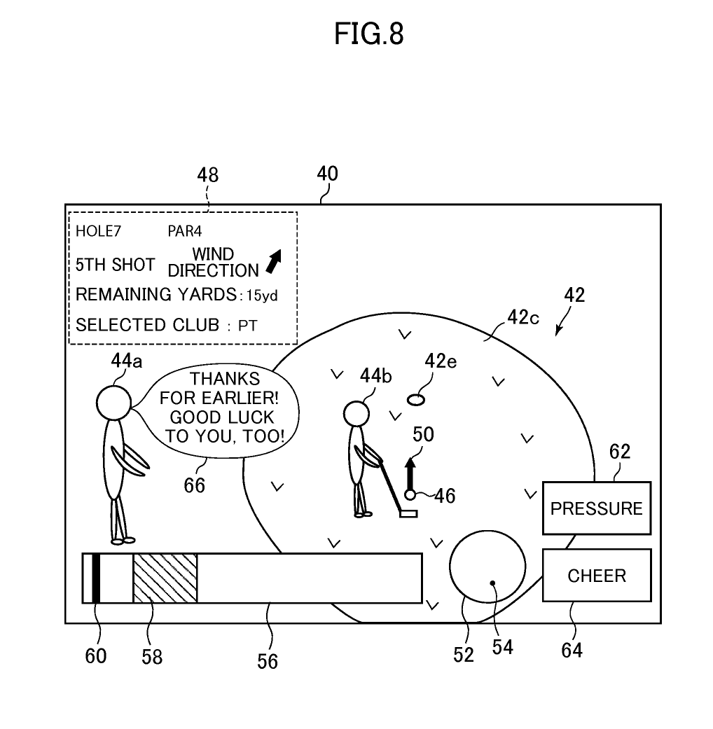

FIG. 8 is a figure illustrating an example of the game screen 40 that is displayed when the second player is cheered on in return. As illustrated in FIG. 8, the impact zone 58 is widened when the second part where the second player plays the game (where the second character 44b takes a shot) arrives. The game screen 40 of this second part further displays the message 66 with which the first player cheers on the second player in return.

This technology is described below in detail.

[1-4. Functions Implemented by the Game System]

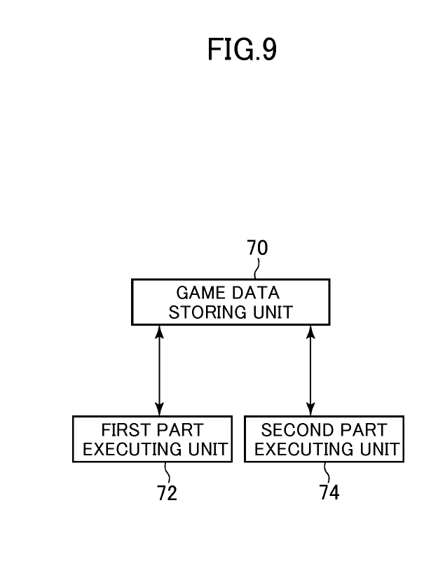

FIG. 9 is a block diagram illustrating functions that are implemented by the game system 1. As illustrated in FIG. 9, a game data storing unit 70, a first part executing unit 72, and a second part executing unit 74 are implemented in the game system 1. Functions described below are implemented by, for example, the control unit 12 of the game device 10A which plays the role of the server by operating as programmed by a program read out of the memory unit 14.

[1-4-1. Game Data Storing Unit]

The game data storing unit 70 is implemented mainly by the memory unit 14 and the main memory unit 16. The game data storing unit 70 stores various kinds of data necessary to execute the golf game.

[Parameter Data]

The game data storing unit 70 stores, for example, parameter data which contains various parameters set in the golf game. A first game parameter about the first part and a second game parameter about the second part, for example, are stored in the game data storing unit 70.

The first game parameter is a parameter that is set in the first part with respect to the game difficulty level in the first part. The second game parameter is a parameter that is set in the second part with respect to the game difficulty in the second part. The difficulty level indicates the difficulty of play to be played by the first player or the second player.

In a competitive game (e.g., a golf game), a change in the first game parameter changes the game difficulty in the first part, and a change in the second game parameter changes the game difficulty in the second part.

For example, a change in the first game parameter gives an advantage or a disadvantage to the first player in the first part, and a change in the second game parameter gives an advantage or a disadvantage to the second player in the second part.

An advantage herein means a situation in the game that is advantageous to the first player or the second player. In other words, “giving an advantage to the first player or the second player” means bringing about a situation that makes it easier for the first player or the second player to advance in the game. For instance, giving an advantage to the first player or the second player increases the chance of the character 44 that is operated by the first player or the second player making a successful shot.

On the other hand, a disadvantage herein means a situation in the game that is disadvantageous to the first player or the second player. In other words, “giving a disadvantage to the first player or the second player” means bringing about a situation that makes it harder for the first player or the second player to advance in the game. For instance, giving a disadvantage to the first player or the second player increases the chance of the character 44 that is operated by the first player or the second player messing up a shot.

This embodiment describes a case where a change in the first game parameter helps the first player to play successfully or unsuccessfully in the first part, and a change in the second game parameter helps the second player to play successfully or unsuccessfully in the second part. “Playing successfully” means that the play yields a given result. In this embodiment, a player “plays successfully” when the cursor 60 stops inside the impact zone 58.

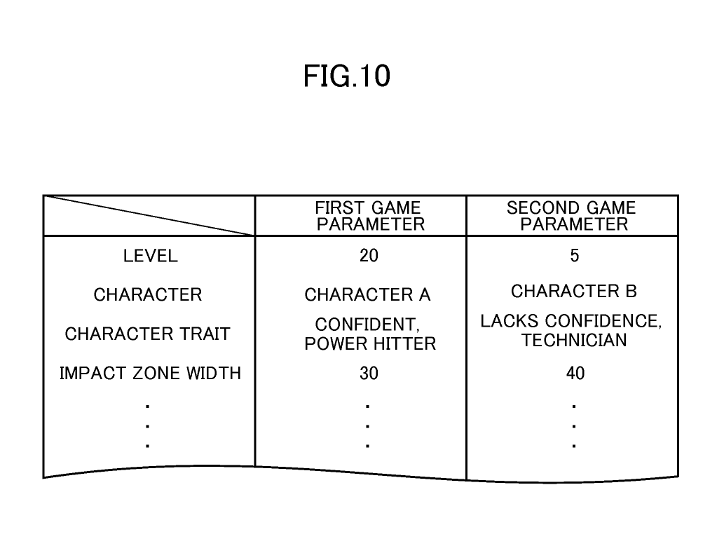

FIG. 10 is a figure illustrating an example of storing data of the first game parameter and the second game parameter. As illustrated in FIG. 10, stored as the first game parameter and the second game parameter are, for example, information about the past performance (e.g., the levels of the characters 44) of the players playing in the respective parts, information about the character traits (e.g., personality and ability) of the characters 44 used by the players, and information about the width of the impact zone 58.

Changes in values stored as the first game parameter and the second game parameter illustrated in FIG. 10 change the game difficulty level. In other words, the changes give an advantage or a disadvantage to the players, thereby helping the players to play successfully or unsuccessfully.

For instance, the difficulty level is lower when the impact zone 58 is wider and stoping the cursor 60 inside the impact zone 58 is accordingly easier. In other words, making a successful shot is easier when the impact zone 58 is wider, which gives an advantage to the current player. On the other hand, the difficulty level rises when, for example, the impact zone 58 is narrower, and stoping the cursor 60 inside the impact zone 58 is accordingly more difficult. In other words, the chance of messing up a shot increases when the impact zone 58 is narrower, which gives a disadvantage to the current player.

[Game Situation Data]

The game data storing unit 70 also stores game situation data about a situation of the game. The game situation data indicates the current situation of the game. Stored as the game situation data are information about the position of the ball 46 of each player, information about the numbers of shots taken on each hole in the round, information about clubs selected by the players, information about the direction of the wind, information about the current hole, and the like.

The contents of the game situation data are updated by, for example, a player's operation or a given algorithm. For instance, a game operation performed by a player causes an update to the contents of the game situation data. When a shot taken by one of the characters 44 changes the position of the ball 46, for example, the game situation data is updated.

The control unit 12 functions as means for obtaining various types of data (e.g., the parameter data and the game situation data) stored in the game data storing unit 70. The control unit 12 also functions as means for updating various types of data (e.g., the parameter data and the game situation data) stored in the game data storing unit 70. Data stored in the game data storing unit 70 is not limited to those of the above-mentioned example, and can be any type of data as long as the data is necessary for the game devices 10 to execute the golf game. For instance, the game data storing unit 70 may store a flag necessary to execute processing of flow charts that are described later.

[1-4-2. First Part Executing Unit]

The first part executing unit 72 is implemented mainly by the control unit 12. The first part executing unit 72 executes a game that is played by a player (e.g., the first player) in the first part based on the first game parameter.

For example, the first part executing unit 72 executes the first part of the golf game by updating the game situation data based on the specifics of the play by the first player and on the first game parameter. The term “specifics of the play” in this embodiment is synonymous with the specifics of a game operation performed by a player.

When the other player (e.g., the second player) performs a supportive operation or an obstructive operation with respect to the current player (e.g., the first player), the first part executing unit 72 changes the first game parameter, to thereby change the game difficulty in the first part where the current player plays.

A supportive operation or an obstructive operation is a game operation performed by the second player in the first part in order to change the first game parameter, and is detected based on a detection signal from operating means (e.g., the operating key unit 20) which are used by the players to perform a game operation. This embodiment describes a case where the act of selecting the pressuring button 62 corresponds to an obstructive operation and the act of selecting the cheering button 64 corresponds to a supportive operation.

The pressuring button 62 and the cheering button 64 may not be displayed on the game screen 40. In this case, the second player performs a supportive operation or an obstructive operation by, for example, pressing a given button of the operating key unit 20. For example, data defining which button of the operating key unit 20 is to be pressed to cause a supportive operation or an obstructive operation may be stored in the game data storing unit 70.

In the case where the second player has performed a supportive operation or an obstructive operation, the first part executing unit 72 changes the first game parameter so that the game difficulty level in the first part becomes higher or lower than normal (i.e., when the second player performs neither a supportive operation nor an obstructive operation). This embodiment describes a case where the first game parameter is changed so that the first player is given an advantage or a disadvantage in the first part, in other words, so that the first player is helped to play successfully or unsuccessfully in the first part.

When the second player selects the pressuring button 62, for example, the first game parameter is changed in a manner that gives a disadvantage to the first player and thereby helps the make the first player play unsuccessfully. An example of how the first game parameter is changed as a result of the second player selecting the pressuring button 62 is to narrow the impact zone 58.

A case where, on the other hand, when the second player selects the cheering button 64, for example, the first game parameter is changed in a manner that gives an advantage to the first player and thereby helps the first player to play successfully is described. An example of how the first game parameter is changed as a result of the second player selecting the cheering button 64 is to widen the impact zone 58.

The first part executing unit 72 also evaluates whether the first player has played successfully or not based on, for example, the specifics of the play by the first player and a given evaluation standard. The evaluation standard is a condition against which the specifics of the play by the first player are compared, and may be stored in the game data storing unit 70 in advance.

In other words, the evaluation standard is a condition indicating whether or not the specifics of the play by the first player have yielded a given result, for example, a condition to be satisfied by the specifics of a game operation performed by the first player. This embodiment describes a case of evaluating whether the first player has played successfully or not by determining whether or not the cursor 60 has stoped inside the impact zone 58.

The play by the first player is evaluated by, for example determining whether or not the cursor 60 has stoped inside the impact zone 58 as a result of the play played by the first player with the width of the impact zone 58 changed. In the case where the cursor 60 has stoped inside the impact zone 58, the play by the first player is evaluated as a success. In the case where the cursor 60 has not stoped inside the impact zone 58, the play by the first player is evaluated as a failure.

[1-4-3. Second Part Executing Unit]

The second part executing unit 74 is implemented mainly by the control unit 12. The second part executing unit 74 executes a game that is played by the other player (e.g., the second player) in the second part based on the second game parameter. For example, the second part executing unit 74 executes the second part of the golf game by updating the game situation data based on the specifics of the play by the second player and on the second game parameter.

When the other player (e.g., the second player) performs a supportive operation or an obstructive operation with respect to a player (e.g., the first player) in the first part, the second part executing unit 74 changes the second game parameter, to thereby change the game difficulty in the second part where the other player plays.

This embodiment describes a case where the second part executing unit 74 determines the second game parameter based on the result of play played by the player of the first part (e.g., the first player) when the first part executing unit 72 has changed the game difficulty in the first part.

In the case where the play result of the first player satisfies a given condition, the second part executing unit 74 changes the second game parameter so that the game difficulty level in the second part is higher or lower than normal (i.e., when the play result of the first player does not satisfy the given condition). The given condition is a condition about the play result of the first player, for example, a condition indicating whether or not the specifics of the play by the first player satisfy the evaluation standard.

The second part executing unit 74 changes the second game parameter in a manner that gives an advantage or a disadvantage to the second player in the second part, in other words, in a manner that helps the second player to play successfully or unsuccessfully. For example, in the case where the first player has played successfully under a situation that gives a disadvantage to the first player and thereby increases the chance of the first player playing unsuccessfully, the second game parameter is changed so that the second player is given a disadvantage and is helped to play unsuccessfully. The second game parameter is changed so that, for example, the impact zone 58 is narrowed when the second player plays, in the case where the cursor 60 has stoped inside the impact zone 58 as a result of play played by the first player with the first game parameter changed to narrow the impact zone 58.

In this case, the game screen 40 displays, for example, the message 66 with which the first character 42a pressures the second character 44b in return as illustrated in FIG. 7. The impact zone 58 is then narrowed when the second character 44b takes a shot, thereby increasing the chance of the second player playing unsuccessfully. The first player in this case may be prevented from selecting the pressuring button 62 and the cheering button 64.

On the other hand, for example, in the case where the first player has played successfully in a situation that gives an advantage to the first player and thereby increases the chance of the first player playing successfully, the second game parameter is changed so that the second player is given an advantage and is helped to play successfully. The second game parameter is changed so that, for example, the impact zone 58 is widened when the second player plays, in the case where the cursor 60 has stopped inside the impact zone 58 as a result of play played by the first player with the first game parameter changed to widen the impact zone 58.

In this case, the game screen 40 displays, for example, the message 66 with which the first character 42a cheers on the second character 44b as illustrated in FIG. 8. The impact zone 58 is then widened when the second character 44b takes a shot, thereby increasing the chance of the second player playing successfully. The first player in this case may also be prevented from selecting the pressuring button 62 and the cheering button 64.

The description given above discusses processing that is executed when the second player selects the pressuring button 62 or the cheering button 64, but the first player may select the pressuring button 62 or the cheering button 64. Processing executed in this case can be described by substituting “first player” and “second player” in the above description of the processing with “second player” and “first player”, respectively, and substituting “first character 44a” and “second character 44b” with “second character 44b” and “first character 44a”, respectively.

[1-5. Processing Executed in the Game System]

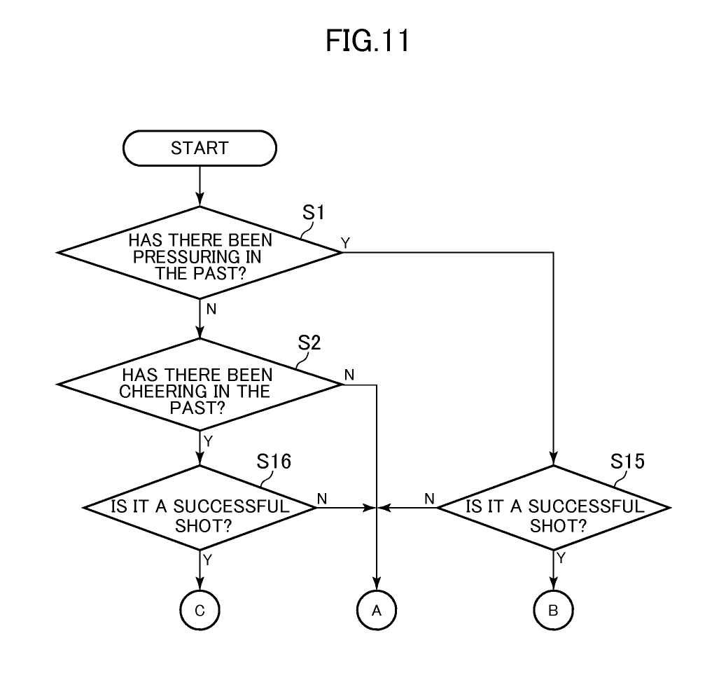

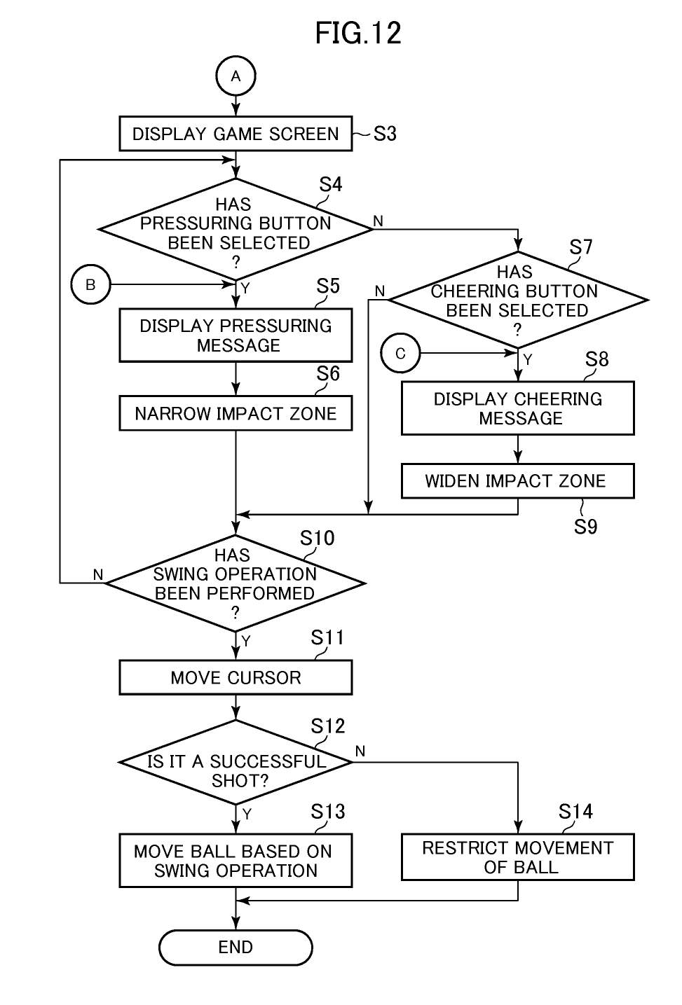

FIGS. 11 and 12 are flow charts illustrating an example of processing that is executed in the game system 1. The operation of the game device 10 that plays the role of the server (e.g., the game device 10A) is described here. The processing of FIGS. 11 and 12 is executed by the control unit 12 by operating as programmed by a program that is read out of the memory unit 14. The processing executed in the first part and the processing executed in the second part are similar to each other. Described below is the processing that is executed in the second part.

As illustrated in FIG. 11, the control unit 12 first determines whether or not the second player has pressured the first player in the past (S1). For example, the control unit 12 determines immediately before the second part arrives whether or not the second player has pressured the first player in the first part. Specifically, whether or not the second player has selected the pressuring button 62 in the first part is determined.

The determination in S1 is conducted by, for example, preparing a flag that indicates whether or not the second player has selected the pressuring button 62 and referring to the value of the flag. This flag takes a value “1” in the case where the second player has selected the pressuring button 62, and takes a value “0” in the case where the second character 44b takes a shot.

When it is determined that the second player has not pressured the first player in the past (S1: N), the control unit 12 determines whether or not the second player has cheered on the first player in the past (S2). For example, the control unit 12 determines immediately before the second part arrives whether or not the second player has cheered on the first player. Specifically, whether or not the second player has selected the cheering button 64 in the first part is determined.

The determination in S2 is conducted by, for example, preparing a flag that indicates whether or not the second player has selected the cheering button 64 and referring to the value of the flag. This flag takes a value “1” in the case where the second player has selected the cheering button 64, and takes a value “0” in the case where the second character 44b takes a shot.

When it is not determined that the second player has cheered on the first player (S2: N), the processing moves to FIG. 12, where the control unit 12 sets the width of the impact zone 58 which is stored as the first game parameter, and displays the game screen 40 (S3). The game screen 40 displayed in S3 is as illustrated in FIG. 3. Specifically, the game screen 40 where the width of the impact zone 58 is not changed (i.e., normal state) is displayed. In this state, the control unit 12 waits for an operation performed by the first player to select the pressuring button 62 or the cheering button 64, or an operation performed by the second player to start the swing of the second character 44b.

The control unit 12 determines whether or not the first player has selected the pressuring button 62 (S4). When it is determined that the first player has selected the pressuring button 62 (S4: Y), the control unit 12 displays on the game screen 40 the message 66 with which the first character 44a pressures the second character 44b (S5). The control unit 12 changes the first game parameter so that the impact zone 58 is narrowed (S6). The width of the impact zone 58 that is displayed in S6 is, for example, narrower than the width of the impact zone 58 that is displayed in S3.

When it is not determined that the first player has selected the pressuring button 62 (S4: N), on the other hand, the control unit 12 determines whether or not the first player has selected the cheering button 64 (S7).

When it is determined that the first player has selected the cheering button 64 (S7: Y), the control unit 12 displays on the display screen 40 the message 66 with which the first character 44a cheers on the second character 44b (S8). The control unit 12 changes the first game parameter so that the impact zone 58 is widened (S9). The width of the impact zone 58 that is displayed in S9 is, for example, wider than the width of the impact zone 58 that is displayed in S3.

When it is not determined that the first player has selected the cheering button 64 (S7: N), the control unit 12 determines whether or not the second player has performed a swing operation for starting the swing of the second character 44b (S10).

When it is not determined that the second player has performed the swing operation (S10: N), the processing returns to S4, where the control unit 12 determines whether or not the first player has selected the pressuring button.

When it is determined that the second player has performed the swing operation (S10: Y), the control unit 12 moves the cursor 60 based on the swing operation of the second player (S11). The processing in S11 is executed as described with reference to FIG. 4. Specifically, the cursor 60 moves the swing gauge 56 in the rightward direction, then moves the swing gauge 56 in the leftward direction, and stops the swing gauge 56.

The control unit 12 determines whether or not the second character 44b has made a successful shot (i.e., whether the second player has played successfully or not) (S12). For example, whether or not the cursor 60 has stopped inside the impact zone 58 is determined based on the specifics of the play (i.e., the swing operation) by the second player.

When it is determined that a successful shot has been made (S12: Y), the control unit 12 moves the ball 46 based on the swing operation of the second player (S13). In S13, the ball 46 is moved based on a direction, a hit point, and a swing strength that are specified by the second player.

When it is not determined that a successful shot has been made (S12: N), the control unit 12 restricts movement of the ball 46 based on the swing operation of the second player (S14). In S14, the movement of the ball 46 based on a direction, a hit point, and a swing strength that are specified by the second player is restricted. For instance, the control unit 12 causes the second character 44b to make a missed shot by determining the carry and moving direction of the ball 46 at random or causing the second character 44b to make an air shot.

Returning to FIG. 11, when it is determined that the second player has pressured the first player (S1: Y), the control unit 12 determines whether or not the first character 44a under pressure has made a successful shot (S15).

The determination of S15 is conducted by, for example, preparing a flag that indicates whether or not the first character 44a has made a successful shot and referring to the value of the flag. This flag takes, for example, a value “1” when the cursor 60 stops inside the impact zone 58 as a result of the swing operation of the first player and a value “0” when the cursor 60 stops outside the impact zone 58.

When it is determined that the first character 44a has made a successful shot (S15: Y), the processing moves to S5. Specifically, the impact zone 58 is narrowed.

When it is not determined that the first character 44a has made a successful shot (S15: N), on the other hand, the processing moves to S3. Specifically, the width of the impact zone 58 is not changed.

When it is determined that the second player has cheered on the first player (S2: Y), the control unit 12 determines whether or not the first character 44a being cheered has made a successful shot (S16).

When it is determined that the first character 44a has made a successful shot (S16: Y), the processing moves to S8. Specifically, the impact zone 58 is widened.

When it is not determined that the first character 44a has made a successful shot (S16: N), on the other hand, the processing moves to S3. Specifically, the width of the impact zone 58 is not changed.

The processing described above is executed in the second part. Processing that is executed when the first part arrives can be described by substituting “first player” and “second player” in the above description of the processing with “second player” and “first player”, respectively, and substituting “first character 44a” and “second character 44b” with “second character 44b” and “first character 44a”, respectively.

According to the game system 1 described above, in the case where the second player has performed a supportive operation or an obstructive operation, the width of the impact zone 58 can be changed when the first character 44a takes a shot so that the golf game difficulty level is changed in the first part. In addition, in the case where the second player has performed a supportive operation or an obstructive operation, the width of the impact zone 58 can be changed when the second character 44b takes a shot so that the golf game difficulty level is changed in the second part.

The width of the impact zone 58 can further be changed when the second character 44b takes a shot based on the result of play that has been played by the first player with the width of the impact zone 58 changed. For example, in the case where the first player has made a great shot despite pressuring by the second player, the first player can pressure the second player in return. Because pressuring the first player means that there is a possibility of the second player being pressured in return, the second player restrains from playing the game so as to constantly pressure the first player, and the game system 1 can thus allow a player to change the game difficulty level of another player while maintaining the fun of the game.

The game parameter described in this embodiment is changed based on the play result of a player who is pressured or cheered on. Alternatively, the game parameter may be changed in a part where one player plays in the case where the player has pressured or cheered on the other player. In other words, the game parameter may be changed in a part where a player who has pressured or cheered on the other player plays, irrespective of the play result of the pressured or cheered player.

### 2. Modification Examples

The present invention is not limited to the embodiment described above, and can be modified suitably without departing from the spirit of the invention.

(1) For instance, the game system 1 may be designed so that the amount of change in the width of the impact zone 58 is varied based on a predetermined method when the pressuring button 62 or the cheering button 64 is selected. The amount of change (the degree of change) in the width of the impact zone 58 may increase or decrease based on, for example, whether or not a given condition such as as those described below is satisfied.

(1-1) For instance, the amount of change in the width of the impact zone 58 when the first character 44a takes a shot may be varied depending on the number of times the second player has selected the pressuring button 62 or the cheering button 64.

In Modification Example (1-1), the other player (e.g., the second player) performs a supportive operation or an obstructive operation one or a plurality of times. For example, the second player selects the pressuring button 62 or the cheering button 64 one or a plurality of times by pressing a given button of the operating key unit 20 one or a plurality of times.

The game data storing unit 70 in Modification Example (1-1) stores data that associates a supportive operation/obstructive operation count with information about a game parameter changing method. The data may be in a table format or an arithmetic expression format. The “game parameter changing method” indicates how the first game parameter or the second game parameter is changed, for example, the amount of change in parameter and/or the type of the parameter to be changed.

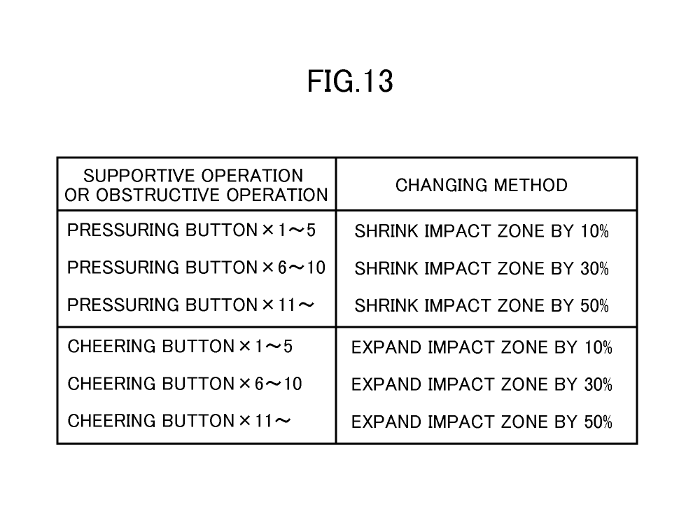

FIG. 13 is a figure illustrating the association between a supportive operation/obstructive operation count and information about a game parameter changing method. For example, the amount of change in game parameter is larger when the supportive operation/obstructive operation count is higher. When the amount of change in game parameter is larger, for example, the game difficulty level in the first part or the second part is higher or lower. In other words, when the amount of change in game parameter is larger, the player is given a greater advantage or disadvantage and is helped to play more successfully or unsuccessfully.

When the number of times the second player selects the pressuring button 62 is larger, for example, the width of the impact zone 58 at the time the first character 44a takes a shot is narrower and the game difficulty level in the first part is higher. On the other hand, when the number of times the second player selects the cheering button 64 is larger, for example, the width of the impact zone 58 at the time the first character 44a takes a shot is wider and the game difficulty level in the first part is lower.

The first part executing unit 72 in Modification Example (1-1) obtains the association data of FIG. 13. The first part executing unit 72 then changes the first game parameter based on a game parameter changing method that is associated with the number of times the other player (e.g., the second player) has performed a supportive operation or an obstructive operation. For instance, the number of times the pressuring button 62 or the cheering button 64 has been selected is stored in the main memory unit 16 or other components, and the first part executing unit 72 obtains a game parameter changing method that is associated with the stored count. The first game parameter is changed based on this changing method.

According to Modification Example (1-1), the degree of pressure on the opponent or the degree of cheering for the opponent can be determined by the number of times a supportive operation or an obstructive operation is performed.

The second part executing unit 74 may determine the second game parameter based on the number of times a supportive operation or an obstructive operation has been performed by the other player (e.g., the second player). For instance, the second part executing unit 74 may change the second game parameter based on a game parameter changing method that is associated with the number of times a supportive operation or an obstructive operation has been performed by the other player (e.g., the second player).

The supportive operation/obstructive operation count is obtained from, for example, the main memory unit 16 and a game parameter changing method that is associated with this count is obtained. The second game parameter is changed based on the changing method. The second game parameter is changed so that, for example, the difficulty level in the second part rises when the difficulty level in the first part increases. In other words, the amount of change in the second game parameter is larger when the amount of change in the first game parameter is larger.

This way, the intensity with which the second player is pressured or cheered on in return increases as, for example, the number of times the second player performs a supportive operation or an obstructive operation rises and the intensity with which the second player pressures or cheers on the first player increases accordingly.

The first game parameter or the second game parameter may be determined based on the number of times a supportive operation or an obstructive operation has been performed by the first player and the number of times a supportive operation or an obstructive operation has been performed by the second player.

The game data storing unit 70 may store, for example, information indicating the number of times the first player has performed a supportive operation or an obstructive operation in the past and information indicating the number of times the second player has performed a supportive operation or an obstructive operation in the past. The supportive operation/obstructive operation count indicated by the information is updated when, for example, the first player or the second player performs a supportive operation or an obstructive operation.

For example, a difference in supportive operation/obstructive operation count may be stored in association with a game parameter changing method. In this case, the first game parameter or the second game parameter may be changed by, for example, a game parameter changing method that is determined based on the result of a comparison between the number of times the first player has performed a supportive operation or an obstructive operation and the number of times the second player has performed a supportive operation or an obstructive operation (e.g., the difference between the two).

(1-2) To give another example, in the case where the second player has selected the pressuring button 62 or the cheering button 64, the amount of change in the width of the impact zone 58 when the first character 44a takes a shot may be varied depending on the level of the first character 44a or the second character 44b.

The game data storing unit 70 in Modification Example (1-2) stores information about the performance of a player (e.g., the first player) or the other player (e.g., the second player) in a game (e.g., a golf game) (e.g., information about the level of the first character 44a or the second character 44b). For example, the game data storing unit 70 stores data that associates information about the performance of the first player or the second player with information about a game parameter changing method. The data may be in a table format or an arithmetic expression format. Performance means the past performance in the golf game.

The information indicating the performance of a player can be any type of information as long as the information is updated based on the specifics of play by the player. Described here is a case where the performance is the level of the character 44. Other examples of performance include experience points earned by the player or the character 44 and information about a title or a rank that is given to the player themselves.

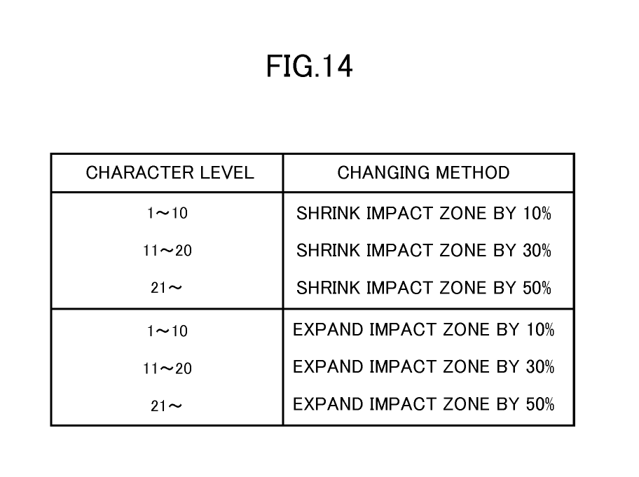

FIG. 14 is a figure illustrating an example of the association between the level of the character 44 and a game parameter changing method. The amount of change in game parameter is larger when, for example, the level of the character 44 is higher (when the performance of the character 44 is higher).

In the case where the second player has selected the pressuring button 62, for example, the width of the impact zone 58 at the time the first character 44a takes a shot is narrower and the game difficulty level in the first part is higher when the level of the first character 44a or the second character 44b is higher. On the other hand, in the case where the second player has selected the cheering button 64, for example, the width of the impact zone 58 at the time the first character 44a takes a shot is wider and the game difficulty level in the first part is lower when the level of the first character 44a or the second character 44b is higher.

The first part executing unit 72 in Modification Example (1-2) determines the first game parameter based on information about the performance of a player (e.g., the first player) or the other player (e.g., the second player) in a game (e.g., a golf game). For instance, the first part executing unit 72 changes the first game parameter based on a parameter changing method that is associated with the performance of a player (e.g., the second player) or the other player (e.g., the first player) (e.g., the level of the second character 44b). Information about the level of the first character 44a or the second character 44b, for example, is obtained from the game data storing unit 70 and a game parameter changing method that is associated with this level is obtained. The first game parameter is changed based on the changing method.

According to Modification Example (1-2), the degree of pressure on the opponent or the degree of cheering for the opponent can be determined by the level of the first character 44a or the second character 44b. For instance, the influence of pressuring or cheering is greater when the level of the first character 44a or the second character 44b is higher.

The second part executing unit 74 may determine the second game parameter based on information about the performance of a player (e.g., the first player) or the other player (e.g., the second player). For instance, the second part executing unit 74 may change the second game parameter based on a game parameter changing method that is associated with the performance of a player (e.g., the first player) or the other player (e.g., the second player).

Information about the level of the first character 44a or the second character 44b, for example, is obtained from the game data storing unit 70 and a game parameter changing method that is associated with this level is obtained. The second game parameter is changed based on the changing method. This way, in the case where the second character 44b who has a high level and a great influence is used to pressure or cheer on the first player, for example, the intensity with which the second character 44b is pressured or cheered on in return can be increased.

The first game parameter or the second game parameter may be determined based on both the performance of the first player and the performance of the second player.

For instance, a difference between the performance of the first player and the performance of the second player may be stored in association with a game parameter changing method. In this case, the first game parameter or the second game parameter may be changed by, for example, a game parameter changing method that is determined based on the result of a comparison between the performance of the first player and the performance of the second player (e.g., the difference between the two).

(1-3) To give still another example, in the case of executing a game in which a player (e.g., the first player) and the other player (e.g., the second player) each operate one of the plurality of characters 44 as in the embodiment, the amount of change in the width of the impact zone 58 at the time the first character 44a takes a shot may be varied depending on the personality and the like of the first character 44a or the second character 44b.

For instance, the plurality of characters 44 are prepared in the game data storing unit 70, and the first player and the second player each select their own character 44 to play the game. The game data storing unit 70 of Modification Example (1-3) stores information about the respective character traits of the plurality of characters 44. This information is stored, for example, in association with the character 44 that the first player or the second player can select. The character trait of one character 44 is a parameter unique to the character 44, for example, the personality or ability (e.g., the ability value or skill) of the character 44.

The game data storing unit 70 also stores data that associates information about the respective character traits of the plurality of characters 44 with information about a game parameter changing method. The data may be in a table format or an arithmetic expression format.

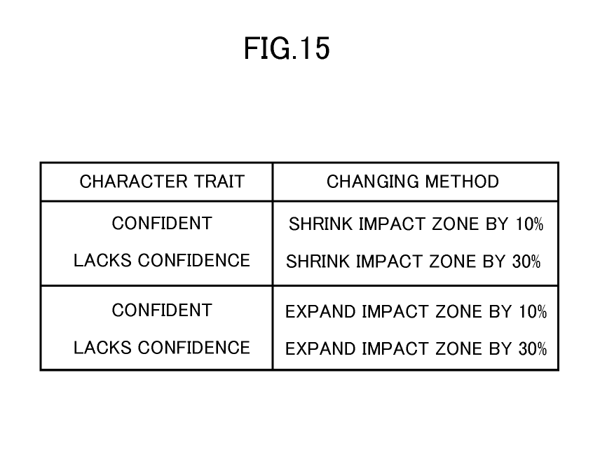

FIG. 15 is a figure illustrating an example of data that associates information about the character traits of the characters 44 with a game parameter changing method. For instance, in the case where the second player selects the pressuring button 62 and the first character 44a has a personality that lacks confidence, the width of the impact zone 58 at the time the first character 44a takes a shot is narrower and the game difficulty level in the first part is higher than when the first character 44a has a confident personality.

For instance, in the case where the second player selects the cheering button 64 and the first character 44a has a personality that lacks confidence, on the other hand, the width of the impact zone 58 at the time the first character 44a takes a shot is wider and the game difficulty level in the first part is lower than when the first character 44a has a confident personality.

The first part executing unit 72 in Modification Example (1-3) determines the first game parameter based on information about the character trait of the character 44 that is operated by a player (e.g., the first player) or the other player (e.g., the second player). The first part executing unit 72 changes the first game parameter by, for example, a game parameter changing method that is associated with the character trait of a character (e.g., the first character 44a or the second character 44b) operated by a player (e.g., the first player) or the other player (e.g., the second player). Information about the character trait of the first character 44a, for example, is obtained from the game data storing unit 70, and a method of changing the first game parameter that is associated with this character trait is obtained. The first game parameter is changed based on the changing method.

According to Modification Example (1-3), the degree of changing the width of the impact zone 58 can be varied depending on the personality and the like of the character 44 that is operated by a player. For instance, the degree of the width change can be varied so that the character 44 having a confident personality is influenced less by pressuring and cheering than the character 44 whose personality lacks confidence.

The description given above is about a case where the amount of change in the first game parameter varies depending on the character trait of the first character 44a. The amount of change in the first game parameter may be varied depending on the character trait of the second character 44b instead. This enables the character 44 having a confident personality to, for example, exert more influence when pressuring or cheering than the character 44 whose personality lacks confidence.

For instance, in the case where the second player selects the pressuring button 62 and the second character 44b has a confident personality, the width of the impact zone 58 at the time the first character 44a takes a shot may be made narrower than when the second character 44b has a personality that lacks confidence, thereby raising the game difficulty level in the first part.

For instance, in the case where the second player selects the cheering button 64 and the second character 44b has a confident personality, on the other hand, the width of the impact zone 58 at the time the first character 44a takes a shot may be made wider than when the second character 44b has a personality that lacks confidence, thereby lowering the game difficulty level in the first part.

The second part executing unit 74 may determine the second game parameter based on, for example, information about the character trait of the character 44 that is operated by a player (e.g., the first player) or the other player (e.g., the second player). The second part executing unit 74 may change the second game parameter based on, for example, a game parameter changing method that is associated with the character trait of a character (e.g., the first character 44a or the second character 44b) operated by a player (e.g., the first player) or the other player (e.g., the second player).

Information about the character trait of the first character 44a or the second character 44b, for example, is obtained from the game data storing unit 70, and a method of changing the second game parameter is obtained based on a game parameter changing method that is associated with this character trait. The second game parameter is changed based on the obtained changing method.

This way, for instance, in the case where the second character 44b who has a great influence pressures or cheers on the opponent, for example, the intensity with which the second character 44b is pressured or cheered on can be increased. The intensity with which the second character 44b is pressured or cheered on in return can be increased also when, for example, the second character 44b pressures or cheers on the first character 44a who is easily influenced.

The amount of change in the first game parameter or the second game parameter may be varied based on both the character trait of the first character 44a and the character trait of the second character 44b.

For instance, a combination of the plurality of characters 44 may be stored in association with a game parameter changing method. In this case, the first game parameter or the second game parameter may be changed based on a changing method that is associated with a combination of the first character 44a and the second character 44b.

(2) The displayed contents of the message 66 may be changed to suit the degree of pressuring on the relevant character 44 or the degree of cheering for the character 44. Specifically, the displayed contents of the message 66 may be varied depending on the amount of change in the first game parameter or the second game parameter.

The first part executing unit 72 in Modification Example (2) includes means for displaying on the game screen 40 an indicator (e.g., the message 66) which indicates that a supportive operation or an obstructive operation has been performed in the case where a player (e.g., the second player) has performed a supportive operation or an obstructive operation. The indicator displayed on the game screen 40 can be a given image and is not limited to the message 66. The indicator displayed on the display screen 40 is also an indicator indicating that the game difficulty in each part has changed, or that the first game parameter or the second game parameter has changed.

(2-1) The display mode and displayed contents of the message 66 may be varied depending on, for example, the number of times the second player has performed a supportive operation or an obstructive operation. For instance, the game data storing unit 70 stores data that associates a supportive operation/obstructive operation count with information about a display method of the indicator (e.g., the message 66). The data may be in a table format or an arithmetic expression format. The information about a display method of the message 66 is about the display mode and displayed contents of the message 66, for example, the number, size, and color of the message 66 and the number of letter strings contained in the message 66.

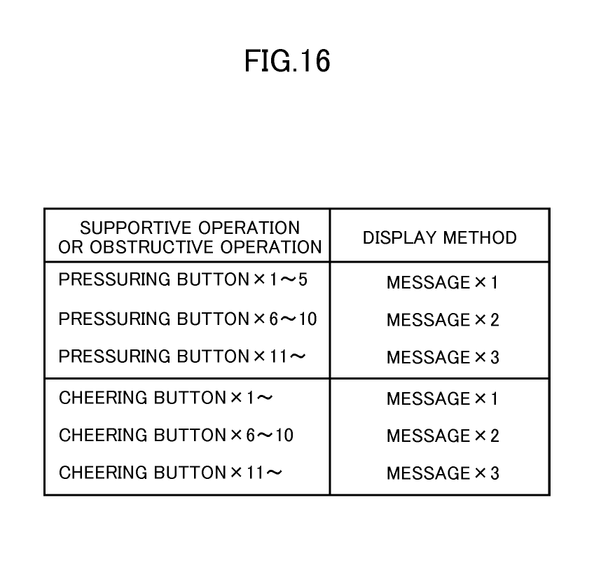

FIG. 16 is a figure illustrating the association between a supportive operation/obstructive operation count and information about a display method of the message 66. The first part executing unit 72 displays on the game screen 40 of the first part an indicator (e.g., the message 66) indicating that the other player (e.g., the second player) has performed a supportive operation or an obstructive operation, based on the supportive operation/obstructive operation count. For example, the first part executing unit 72 displays an indicator (e.g., the message 66) on the game screen 40 based on a display method that is associated with a supportive operation/obstructive operation count of a player (e.g., the second player).

The first part executing unit 72 obtains a supportive operation/obstructive operation count stored in the main memory unit 16 and displays the message 66 on the game screen 40 based on a display method that is associated with the count. For example, the number of the messages 66 is larger when the supportive operation/obstructive operation count is higher. The message 66 is also larger in size when the supportive operation/obstructive operation count is higher.

According to Modification Example (2-1), the display mode and displayed contents of the message 66 can be varied depending on the supportive operation/obstructive operation count.

The second part executing unit 74 may display on the game screen 40 of the second part an indicator (e.g., the message 66) indicating that the other player (e.g., the second player) has performed a supportive operation or an obstructive operation, based on the supportive operation/obstructive operation count. The second part executing unit 74 may display an indicator (e.g., the message 66) on the game screen 40 based on, for example, a display method that is associated with the supportive operation/obstructive operation count of the player (e.g., the second player).

For example, the supportive operation/obstructive operation count is obtained from the main memory unit 16 and a display method associated with the count is obtained. The message 66 is displayed based on the display method. The message 66 is displayed so that, for example, more messages 66 are displayed on the game screen 40 of the second part when the supportive operation/obstructive operation count is higher.

This way, the intensity with which the second player is pressured or cheered on in return can be increased by, for example, raising the number of times that the second player performs a supportive operation or an obstructive operation and increasing the intensity with which the second player pressures or cheers on the first player.

The message 66 may be displayed on the game screen 40 based on the supportive operation/obstructive operation count of the first player and the supportive operation/obstructive operation count of the second player.

For instance, a difference in supportive operation/obstructive operation count may be stored in association with a display method of the message 66. In this case, the message 66 may be displayed by, for example, a display method of the message 66 that is determined based on the result of a comparison between the supportive operation/obstructive operation count of the first player and the supportive operation/obstructive operation count of the second player (e.g., the difference between the two).

(2-2) The display mode and displayed contents of the message 66 may be varied depending on, for example, the levels of the characters 44. For instance, the game data storing unit 70 stores data that associates information about the performance of a player (e.g., the first player) or the other player (e.g., the second player) in the game (e.g., the level of the relevant character 44) with information about a display method of the indicator (e.g., the message 66). The data may be in a table format or an arithmetic expression format.

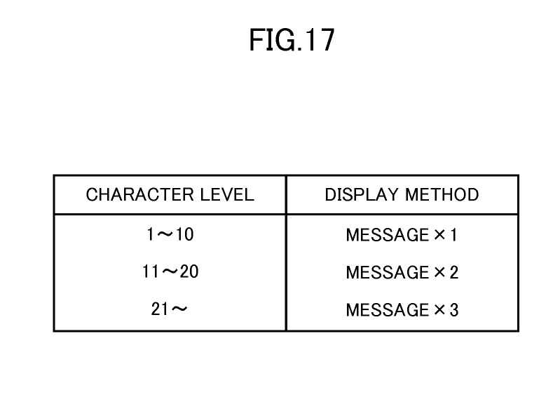

FIG. 17 is a figure illustrating the association between a level of the character 44 and information about a display method of the message 66. The first part executing unit 72 displays on the game screen 40 of the first part an indicator (e.g., the message 66) indicating that the other player (e.g., the second player) has performed a supportive operation or an obstructive operation, based on information about the performance of the player (e.g., the first player) or the other player in the game. For example, the first part executing unit 72 displays the indicator (e.g., the message 66) on the game screen 40 based on a display method that is associated with the performance of the player (e.g., the first player) or the other player (e.g., the second player).

The first part executing unit 72 displays the message 60 on the game screen 40 based on a display method that is associated with the level of the first character 44a which is stored as the first game parameter, or the level of the second character 44b which is stored as the second parameter. In the case where the second player has selected the pressuring button 62 or the cheering button 64, the number of the messages 66 is larger when, for example, the level of the second character 44b is higher. The number of the messages 66 is also larger when, for example, the level of the first character 44a is higher in the case where the second player has selected the pressuring button 62 or the cheering button 64.

According to Modification Example (2-2), the display mode and displayed contents of the message 66 can be varied depending on the levels of the characters 44.

The second part executing unit 74 may display on the game screen 40 of the second part an indicator (e.g., the message 66) indicating that the other player (e.g., the second player) has performed a supportive operation or an obstructive operation, based on information about the performance of the player or the other player in the game. The second part executing unit 74 may display an indicator (e.g., the message 66) on the game screen 40 based on, for example, a display method that is associated with information about the performance of the player or the other player in the game.

For example, information about the performance of the player or the other player in the game is obtained from the main memory unit 16 and a display method associated with the information is obtained. The message 66 is displayed based on the display method. The message 66 is displayed so that, for example, more messages 66 are displayed on the game screen 40 of the second part when the performance of the player or the other player in the game is higher.

This way, the intensity with which the second player is pressured or cheered on in return can be increased by, for example, enhancing the performance of second player in the game and increasing the intensity with which the second player pressures or cheers on the first player.

The message 66 may be displayed on the game screen 40 based on both the performance of the first player and the performance of the second player.

For instance, a difference between the performance of the first player and the performance of the second player may be stored in association with a display method of the message 66. In this case, the message 66 may be displayed by, for example, a display method of the message 66 that is determinedbased on the result of a comparison between the performance of the first player and the performance of the second player (e.g., the difference between the levels of the two).

(2-3) In the case of executing a game in which a player (e.g., the first player) and the other player (e.g., the second player) each operate one of the plurality of characters 44 as in the embodiment, the display mode and displayed contents of the message 66 may be varied depending on, for example, the personality and the like of the character 44.

For instance, the game data storing unit 70 stores data that associates information about the character trait of one character 44 with information about a display method of the indicator (e.g., the message 66). The data may be in a table format or an arithmetic expression format.

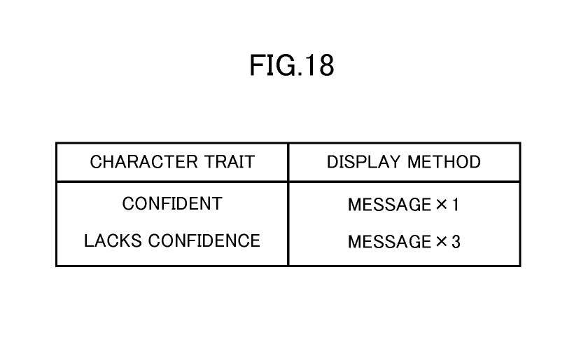

FIG. 18 is a figure illustrating the association between a character trait of the character 44 and information about a display method of the message 66. The first part executing unit 72 displays on the game screen 40 of the first part an indicator (e.g., the message 66) indicating that the other player (e.g., the second player) has performed a supportive operation or an obstructive operation, based on information about the character trait of the character 44 operated by the player (e.g., the first player) or the other player. For example, the first part executing unit 72 displays the indicator (e.g., the message 66) on the game screen 40 based on a display method that is associated with the character trait of the character 44 operated by the player (e.g., the first player) or the other player (e.g., the second player).

The first part executing unit 72 displays the message 60 on the game screen 40 based on a display method that is associated with the character trait of the first character 44a which is stored as the first game parameter, or the character trait of the second character 44b which is stored as the second parameter. In the case where the first character 44a has a personality that lacks confidence, for example, the number of the messages 66 is larger than when the first character 44a has a confident personality. The number of the messages 66 is also larger when, for example, the second character 44b has a personality that lacks confidence than when the second character 44b has a confident personality.

According to Modification Example (2-3), the display mode and displayed contents of the message 66 can be varied depending on the character traits of the characters 44.

The second part executing unit 74 may display on the game screen 40 of the second part an indicator (e.g., the message 66) indicating that the other player (e.g., the second player) has performed a supportive operation or an obstructive operation, based on information about the character trait of the character 44 operated by the player (e.g., the first player) or the other player. The second part executing unit 74 may display an indicator (e.g., the message 66) on the game screen 40 based on, for example, a display method that is associated with information about the character trait of the character 44 operated by the player (e.g., the first player) or the other player.

For example, information about the character trait of the character 44 operated by the player (e.g., the first player) or the other player is obtained from the main memory unit 16 and a display method associated with the information is obtained. The message 66 is displayed based on the display method. The message 66 is displayed so that, for example, more messages 66 are displayed on the game screen 40 of the second part when the character 44 operated by the player or the other player in the game lacks confidence.

This way, for example, in the case where the second character 44b who has a great influence pressures or cheers on the opponent, the intensity with which the second character 44b is pressured or cheered on in return can be increased. The intensity with which the second character 44b is pressured or cheered on in return can also be increased when, for example, the second character 44b pressures or cheers on the first character 44a who is easily influenced.

The message 66 may be displayed on the game screen 40 based on the character trait of the first character 44a and the character trait of the second character 44b both.

For instance, a combination of the plurality of characters 44 may be stored in association with a display method of the message 66. In this case, the message 66 may be displayed by, for example, a display method that is associated with a combination of the first character 44a and the second character 44b.

(3) The amount of change in the second game parameter may be varied depending on, for example, the play result of the first player in the first part.

The game data storing unit 70 stores data that associates information about the play result of a player (e.g., the first player) with information about a game parameter changing method. The data may be in a table format or an arithmetic expression format. An example of information that is stored as the information about the play result is a condition to be satisfied by the play result of the first player, for example, the degree of success of the play by the first player.

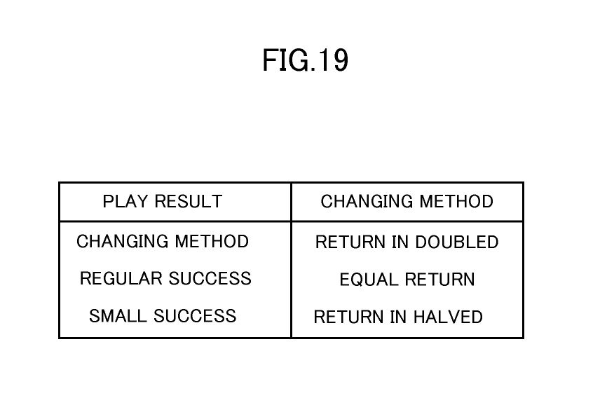

FIG. 19 is a figure illustrating the association between information about a play result of the first player and information about a game parameter changing method. The second part executing unit 74 changes the second game parameter based on a game parameter changing method that is associated with a play result of the player (e.g., the first player).

The second game parameter changes based on, for example, a changing method that is associated with a play result of the first player. The degree of success of play is higher when, for example, the cursor 60 stops closer to the center of the impact zone 58. The amount of change in the second game parameter is larger when, for example, the degree of success of the play by the first player is higher.

According to Modification Example (3), the method of changing the second game parameter can be determined by the play result of the first player.

The character trait of the first character 44a may be changed depending on the play result of the first player. For instance, the character trait of the first character 44a may be changed when the play result of the first player satisfies a given condition.

(4) In the case where the first player plays unsuccessfully under pressure caused by the second player, for example, the second player may be given an advantage. Specifically, in the case where the first player plays unsuccessfully after being given a disadvantage which increases the chance of the first player failing, the second game parameter may be changed in a manner that gives an advantage to the second player and thereby helps the second player to succeed.

For instance, in the case where the cursor 60 does not stop inside the impact zone 58 as a result of play played by the first player with the first game parameter changed so as to narrow the impact zone 58, the second game parameter may be changed so that the impact zone 58 becomes wider when the second player plays.

On the other hand, in the case where the first player plays unsuccessfully while being cheered on by the second player, for example, the second player may be given a disadvantage. Specifically, in the case where the first player plays unsuccessfully after being given an advantage which increases the chance of the first player succeeding, the second game parameter may be changed in a manner that gives a disadvantage to the second player and thereby encourages the second player to fail.

For instance, in the case where the cursor 60 does not stop inside the impact zone 58 as a result of play played by the first player with the first game parameter changed so as to widen the impact zone 58, the second game parameter may be changed so that the impact zone 58 becomes narrower when the second player plays.

(5) For example, the game screen 40 displayed on the game machine 10A which is operated by the first player and the game screen 40 displayed on the game machine 10B which is operated by the second player may be the same or may be different from each other.

(6) The embodiment has described a case of executing processing that changes the width of the impact zone 58 as an example of the method of changing a parameter for changing the game difficulty level in the first part or the second part. However, the parameter changing method is not limited to the example in the embodiment. Any method can be used as long as the parameter is changed in a manner that gives an advantage or a disadvantage to a player of a golf game and thereby helps the player to play successfully or unsuccessfully.

To give another example, a parameter indicating the moving speed of the cursor 60 may be changed. In this case, stoping the cursor 60 inside the impact zone 58 is more difficult for a player and the game difficulty level accordingly rises when the moving speed of the cursor 60 is higher.

Specifying a hit point with the use of the hit point icon 54 is more difficult when, for example, the ball mark 52 is smaller. The game difficulty level may be raised by changing a parameter that indicates the size of the ball mark 52. The game difficulty level may also be raised by, for example, changing the ability value of the relevant character 44.

(7) The method of evaluating the specifics of play by a player is not limited to the example in the embodiment. Any method can be used as long as the specifics of play by a player are evaluated by comparison against the evaluation standard. To give an example of an alternative, it may be determined that the play result does not satisfy a given condition when the cursor 60 stops inside the impact zone 58 but the carry of the ball 46 falls short of a reference value.

(8) Described above is a case of executing a golf game in the game system 1. The game system 1, however, may execute other games. Other games that can be executed are, for example, other competitive sports games besides a golf game (e.g., PK shootout of a soccer game, a bowling game, and a billiard game). In those games, game parameters are changed so as to change the difficulty level in each part.

In addition, examples of games executed in the game system 1 do not need to be competitive games. For instance, a cooperative role-playing game in which a plurality of players cooperate to advance in the game may be executed. In the case of a cooperative role-playing game in which a plurality of players cooperate to advance in the game, for example, one of the players may perform a supportive operation or an obstructive operation while it is the turn of another player to attack, to thereby change the difficulty level of this other player (e.g., an increase or decrease in hit probability and an increase in an ability parameter of the character). In this case, the difficulty level of the one player in their next turn to attack may be changed depending on whether or not the attack in the other player's attack turn has succeeded.

The present invention may further be applied to, for example, a competitive game that is executed with the use of cards (game data) held by respective players (hereinafter simply referred to as card game). For example, in a game that includes a first part where a card held by the first player competes with an opponent (e.g., a boss character) and a second part where a card held by the second player (e.g., another player who is a companion of the first player) competes with an opponent, the first part executing unit 72 may change a game parameter about the card held by the first player (e.g., the ability value of a character indicated by the card) based on a supportive operation or obstructive operation of the second player. In the case where the second player has performed an operation supportive or obstructive to the player in the first part, the second part executing unit 74 in this case changes a game parameter about the card held by the second player.

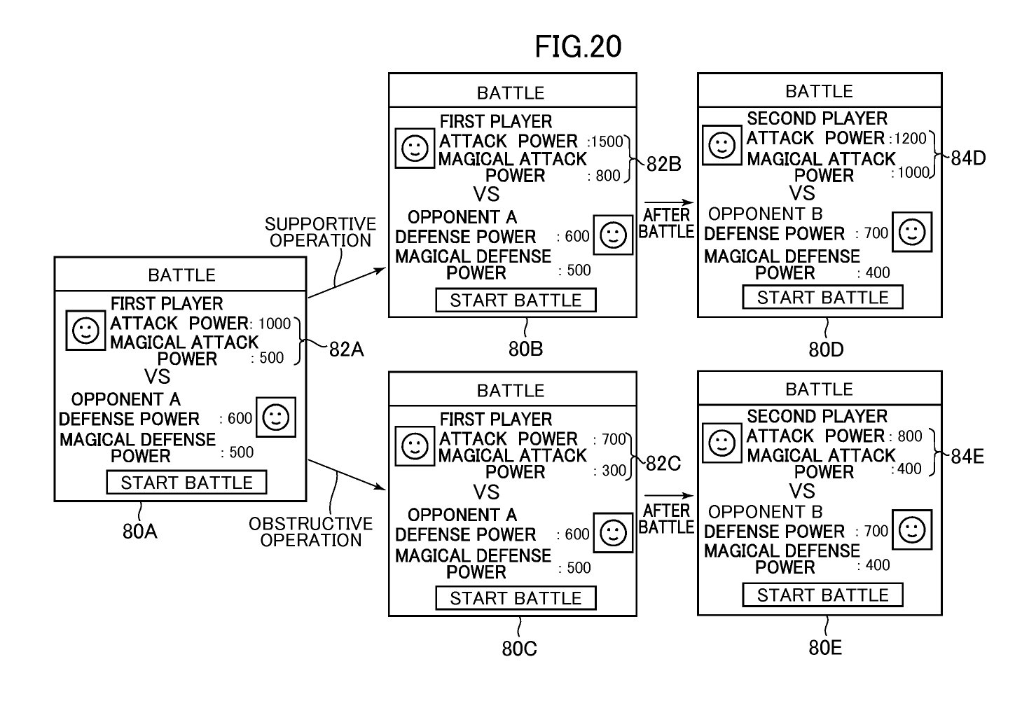

FIG. 20 is a figure outlining processing that is executed when the present invention is applied to a game system for executing a card game. Here, screens displayed on the game device 10A of the first player are referred to as game screens 80A, 80B, and 80C, whereas screens displayed on the game device 10B of the second player are referred to as game screens 80D and 80E.

The game screen 80A is a screen that is displayed on the game device 10A of the first player in the case where the second player performs neither a supportive operation nor an obstructive operation. The card held by the first player has two types of ability values here, “attack power” and “magical attack power”, which take a value “1,000” and a value “500”, respectively. In the game screen 80A, where the second player performs neither a supportive operation nor an obstructive operation, the ability values of the card held by the first player are not changed, as can be seen in an ability value image 82A.

When the second player performs a supportive operation, for example, the ability values of the card held by the first player improve as illustrated in an ability value image 82B of the game screen 80B. For instance, the “attack power” and “magical attack power” of the card held by the first player rise to “1,500” and “800”, respectively. This lowers the difficulty level of a battle between the card held by the first player and the opponent.

The game system may be designed so that conducting a battle between the first player and the opponent in this state improves the ability values of the card held by the second player and lowers the difficulty level of a battle between the card held by the second player and an opponent. For example, in the case where the “attack power” and “magical attack power” of the card held by the second player have been “1,000” and “800”, respectively, the “attack power” and the “magical attack power” rise to “1,200” and “1,000”, respectively, as illustrated in an ability value image 84D of the game screen 80D.

When the second player performs an obstructive operation, on the other hand, the ability values of the card held by the first player drop, as illustrated in an ability value image 82C of the game screen 80C. For instance, the “attack power” and “magical attack power” of the card held by the first player drop to “700” and “300”, respectively. This raises the difficulty level of a battle between the card held by the first player and the opponent.

The game system may be designed so that conducting a battle between the first player and the opponent in this state drops the ability values of the card held by the second player and raises the difficulty level of a battle between the card held by the second player and an opponent. For example, the “attack power” and the “magical attack power” drop to “800” and “400”, respectively, as illustrated in an ability value image 84E of the game screen 80E.

In the case of applying the present invention to the game described above, too, the degree of change in game parameter in the second part may be determined based on the result of the first player in the first part, as in the embodiment. For instance, in the case where the first player wins while supported by a supportive operation of the second player, the ability values of the card held by the second player may increase by an amount larger than when the first player loses. Similarly, in the case where the first player loses while subjected to an obstructive operation of the second player, the ability values of the card held by the second player may decrease by an amount smaller than when the first player wins.

The description given above deals with a case of applying the present invention to a competitive game that uses cards, but games executed in the game system 1 are not limited thereto. The game system 1 may execute a competitive game that uses, for example, figures or character objects of the game instead of cards. For instance, an ability value of a figure or character object of the first player improves or drops as a result of the second player performing a supportive operation or an obstructive operation. In this case, too, an ability value of a figure or character object of the second player may improve or drop based on the result of the first player as in the above description.

(9) The embodiment has described a case where one of the game devices 10 included in the game system 1 plays the role of a server. Alternatively, the game system 1 may include a game server. In this case, the game devices 10 operated by the respective players transmits the specifics of operations to the game server. The game server which receives the specifics of operations from the respective game devices 10 operates the same way as in the game devices 10 in the embodiment.

The game server updates game situation data based on the specifics of operations collected from the respective game devices 10. The updated game situation data is distributed to the game devices 10. The game devices 10 display a game screen based on the distributed game situation data.

The game devices 10 operated by the respective players may include only means for receiving the player's operation and means for displaying a game screen, while means for executing the respective parts of a game (here, means for changing the game difficulty level) may be included in the game server. Specifically, in this case, each player performs an operation via a browser of the game device 10 and a screen of the browser is updated to reflect the result of a game executed by the game server. The game system 1 may thus be designed so that a game server has overall control of a game executed in the game system 1.

As another alternative to the case described in the embodiment, where one of the game devices 10 plays the role of a game server, the game devices 10 may exchange data indicating the specifics of the player's operation with one another. In this case, the game devices 10 update the game situation data by obtaining the specifics of operations of other players via a network. The game situation data updated in the respective game machines 10 may maintain consistency through periodic exchange with one another.

The game system 1 which includes a plurality of game devices 10 in the embodiment may instead include one game device 10. In this case, the first player and the second player compete with each other by using the operating key unit 20 that is included in the same game device 10.

(10) The number of players may be two or more, for example. In this case, one player may be pressured or cheered on by a plurality of other players. Instead of a competition between players which has been described, the other player may be a computer (CPU player). Specifically, the player may pressure or cheer on the computer, and may be pressured or cheered on in return depending on the specifics of play by the computer.

1. A game device for executing a game that comprises a first part where a player plays the game and a second part where another player plays the game, the game device comprising:
first part executing means for executing the game that is played by the player in the first part, based on a first game parameter; and
second part executing means for executing the game that is played by the other player in the second part, based on a second game parameter,
wherein, in a case where the other player performs any one of a supportive operation and an obstructive operation with respect to the player, the first part executing means changes the first game parameter to change a game difficulty level in the first part where the player plays, and
wherein, in a case where the other player has performed any one of the supportive operation and the obstructive operation with respect to the player in the first part, the second part executing means changes the second game parameter to change a game difficulty level in the second part where the other player plays.

2. The game device according to claim 1, wherein the second part executing means determines the second game parameter based on a result of play that has been played by the player with the game difficulty level in the first part changed by the first part executing means.

3. The game device according to claim 1,
wherein the other player performs any one of the supportive operation and the obstructive operation one or a plurality of times, and
wherein the first part executing means determines the first game parameter based on a number of times that the other player has performed any one of the supportive operation and the obstructive operation.

4. The game device according to claim 3, wherein the second part executing means determines the second game parameter based on the number of times that the other player has performed any one of the supportive operation and the obstructive operation.

5. The game device according to claim 1, further comprising means for obtaining information about performance of any one of the player and the other player in the game, from means for storing the information,
wherein the first part executing means determines the first game parameter based on the information about the performance of any one of the player and the other player in the game.

6. The game device according to claim 5, wherein the second part executing means determines the second game parameter based on the information about the performance of any one of the player and the other player.

7. The game device according to claim 1,
wherein the game comprises a game in which the player and the other player each operate one of a plurality of characters,
wherein the game device further comprises means for obtaining information about a characteristic trait of each of the plurality of characters, from means for storing the information, and
wherein the first part executing means determines the first game parameter based on the information about the character trait of the one of the plurality of characters that is operated by any one of the player and the other player.

8. The game device according to claim 7, wherein the second part executing means determines the second game parameter based on the information about the character trait of the one of the plurality of characters that is operated by any one of the player and the other player.

9. The game device according to claim 1,
wherein the other player performs any one of the supportive operation and the obstructive operation one or a plurality of times, and
wherein the first part executing means displays, on a game screen of the first part, an indicator indicating that the other player has performed any one of the supportive operation and the obstructive operation, based on a number of times that any one of the supportive operation and the obstructive operation has been performed.

10. The game device according to claim 9, wherein the second part executing means displays, on a game screen of the second part, an indicator indicating that the other player has performed any one of the supportive operation and the obstructive operation, based on the number of times that any one of the supportive operation and the obstructive operation has been performed.

11. The game device according to claim 1, further comprising means for obtaining information about performance of any one of the player and the other player in the game, from means for storing the information,
wherein the first part executing means displays, on a game screen of the first part, an indicator indicating that the other player has performed any one of the supportive operation and the obstructive operation, based on the information about the performance of any one of the player and the other player in the game.

12. The game device according to claim 11, wherein the second part executing means displays, on a game screen of the second part, an indicator indicating that the other player has performed any one of the supportive operation and the obstructive operation, based on the information about the performance of any one of the player and the other player in the game.

13. The game device according to claim 1,
wherein the game comprises a game in which the player and the other player each operate one of a plurality of characters,
wherein the game device further comprises means for obtaining information about a characteristic trait of each of the plurality of characters, from means for storing the information, and
wherein the first part executing means displays, on a game screen of the first part, an indicator indicating that the other player has performed any one of the supportive operation and the obstructive operation, based on the information about the character trait of the one of the plurality of characters that is operated by any one of the player and the other player.

14. The game device according to claim 13, wherein the second part executing means displays, on a game screen of the second part, an indicator indicating that the other player has performed any one of the supportive operation and the obstructive operation, based on the information about the character trait of the one of the plurality of characters that is operated by any one of the player and the other player.

15. A game system for executing a game that comprises a first part where a player plays the game and a second part where another player plays the game, the game system comprising:
first part executing means for executing the game that is played by the player in the first part, based on a first game parameter; and
second part executing means for executing the game that is played by the other player in the second part, based on a second game parameter,
wherein, in a case where the other player performs any one of a supportive operation and an obstructive operation with respect to the player, the first part executing means changes the first game parameter to change a game difficulty level in the first part where the player plays, and
wherein, in a case where the other player has performed any one of the supportive operation and the obstructive operation with respect to the player in the first part, the second part executing means changes the second game parameter to change a game difficulty level in the second part where the other player plays.

16. A method of controlling a game device for executing a game that comprises a first part where a player plays the game and a second part where another player plays the game, the method comprising:
a first part executing step of executing the game that is played by the player in the first part, based on a first game parameter; and
a second part executing step of executing the game that is played by the other player in the second part, based on a second game parameter,
wherein the first part executing step comprises changing, in a case where the other player performs any one of a supportive operation and an obstructive operation with respect to the player, the first game parameter to change a game difficulty level in the first part where the player plays, and
wherein the second part executing step comprises changing, in a case where the other player has performed any one of the supportive operation and the obstructive operation with respect to the player in the first part, the second game parameter to change a game difficulty level in the second part where the other player plays.

17. A non-transitory computer-readable information storage medium having recorded thereon a program for causing a computer to function as a game device for executing a game that comprises a first part where a player plays the game and a second part where another player plays the game, the game device comprising:
first part executing means for executing the game that is played by the player in the first part, based on a first game parameter; and
second part executing means for executing the game that is played by the other player in the second part, based on a second game parameter,
wherein, in a case where the other player performs any one of a supportive operation and an obstructive operation with respect to the player, the first part executing means changes the first game parameter to change a game difficulty level in the first part where the player plays, and
wherein, in a case where the other player has performed any one of the supportive operation and the obstructive operation with respect to the player in the first part, the second part executing means changes the second game parameter to change a game difficulty level in the second part where the other player plays.

18. (canceled)
